(19) United States
(12) Patent Application Publication
(10) Pub. No.: US 2013/0222749 A1
(43) Pub. Date: Aug. 29, 2013

(54) REFLECTIVE LIQUID CRYSTAL DISPLAY DEVICE

(71) Applicants: DONGGUAN MASSTOP LIQUID CRYSTAL DISPLAY CO., LTD, (US); WINTEK CORPORATION, (US)

(72) Inventors: Hsien-Wei Chiang, Taipei City (TW); Chih-Yuan Wang, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/778,135

(22) Filed: Feb. 27, 2013

(30) Foreign Application Priority Data
Feb. 29, 2012 (TW) 101106500

(51) Int. Cl. G02F 1/1335

(52) U.S. Cl. CPC G02F 1/133512
USPC 349/113

(57) ABSTRACT

A reflective liquid crystal display device includes an upper substrate, a lower substrate, a plurality of isolation structures, and a plurality of photoreactive liquid crystals. The lower substrate is disposed opposite to the upper substrate. The isolation structures are disposed between the upper substrate and the lower substrate for forming a plurality of channels between the upper substrate and the lower substrate. Each of the photoreactive liquid crystals is disposed in each of the channels. The upper substrate is used to block ultraviolet.

### BACKGROUND OF THE INVENTION

1. Field of the Invention

The present invention relates to a display device, and more particularly, to a reflective liquid crystal display device.

2. Description of the Prior Art

Compact designs and low power consumptions may be realized in reflective liquid crystal display devices because backlight units are not required for the reflective liquid crystal display. Among all kinds of liquid crystals, the cholesteric liquid crystal is suitable for the low power consumption reflective liquid crystal display device because the cholesteric liquid crystal may be employed to selectively reflect light within a wavelength range and be kept in a bistable state when applied voltages are removed.

The common manufacturing method of a single-layer color cholesteric liquid crystal display device includes a method of filling up the cholesteric liquid crystal, so as to reflect light with different specific wavelengths, such as the inkjet printing technology and the pixelized vacuum filling (PVF) technology, in order to achieve the full color display. But the inkjet printing technology has high equipment cost. The PVF technology may fill the cholesteric liquid crystals for reflecting light with different specific wavelength separately in order to avoid the contamination. But, the repetition of the filling processes of the cholesteric liquid crystal, the package shape of the channels, the sealing and cutting processes would complicate the manufacturing process and adversely affect the yield.

Accordingly, additives for inducing the photoreactive characteristic of the cholesteric liquid crystal have been developed. In other words, after the exposure to light with proper wavelength and proper energy, such as ultraviolet, the cholesteric liquid crystal used to reflect blue light may be modified to reflect red or green light. Therefore, the cholesteric liquid crystal having the photoreactive characteristics used in the PVF technology can simplify the manufacturing process of the PVF technology. However, the cholesteric liquid crystal having the photoreactive characteristics also tends to be affected by the ambient light irradiating subsequently, and the reliability of the reflective liquid crystal is accordingly influenced. Consequently, how to improve the reliability of the reflective liquid crystal display device using the photoreactive cholesteric liquid crystals and meanwhile ensure the display quality of the reflective liquid crystal display device is still an important issue in this field.

### SUMMARY OF THE INVENTION

It is one of the objectives of the present invention to provide a reflective liquid crystal display device. A substrate capable of blocking ultraviolet is employed to keep ambient light from deteriorating photoreactive liquid crystals which are employed to generate reflective display effects. The reliability of the reflective liquid crystal display device is accordingly enhanced.

To achieve the purposes described above, a preferred embodiment of the present invention provides a reflective liquid crystal display device. The reflective liquid crystal display device includes an upper substrate, a lower substrate, a plurality of isolation structures, and a plurality of photoreactive liquid crystals. The lower substrate is disposed opposite to the upper substrate. The isolation structures are disposed between the upper substrate and the lower substrate to form a plurality of channels between the upper substrate and the lower substrate. Each of the photoreactive liquid crystals is respectively disposed in each of the channels. The upper substrate is used to block ultraviolet.

In the reflective liquid crystal display device of the present invention, the substrate capable of blocking ultraviolet is employed to keep ambient light from deteriorating the photoreactive liquid crystals and enhance the reliability of the reflective liquid crystal display device accordingly. In addition, an anti-reflection device may also be employed in the reflective liquid crystal display device of the present invention so as to improve the display effects of the reflective liquid crystal display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a reflective liquid crystal display device according to a first preferred embodiment of the present invention.

FIG. 2 is a schematic diagram illustrating an exposure process executed to the reflective liquid crystal display device according to the first preferred embodiment of the present invention.

FIG. 3 is a schematic diagram illustrating a reflective liquid crystal display device according to a second preferred embodiment of the present invention.

FIG. 4 is a schematic diagram illustrating a reflective liquid crystal display device according to a third preferred embodiment of the present invention.

FIG. 5 is a schematic diagram illustrating a reflective liquid crystal display device according to a fourth preferred embodiment of the present invention.

FIG. 6 is a schematic diagram illustrating a reflective liquid crystal display device according to a fifth preferred embodiment of the present invention.

FIG. 7 is a schematic diagram illustrating a reflective liquid crystal display device according to a sixth preferred embodiment of the present invention.

FIG. 8 is a schematic diagram illustrating a reflective liquid crystal display device according to a seventh preferred embodiment of the present invention.

FIG. 9 is a schematic diagram illustrating a reflective liquid crystal display device according to an eighth preferred embodiment of the present invention.

FIG. 10 is a schematic diagram illustrating a reflective liquid crystal display device according to a ninth preferred embodiment of the present invention.

FIG. 11 is a schematic diagram illustrating a reflective liquid crystal display device according to a tenth preferred embodiment of the present invention.

FIG. 12 is a schematic diagram illustrating a reflective liquid crystal display device according to an eleventh second preferred embodiment of the present invention.

### DETAILED DESCRIPTION

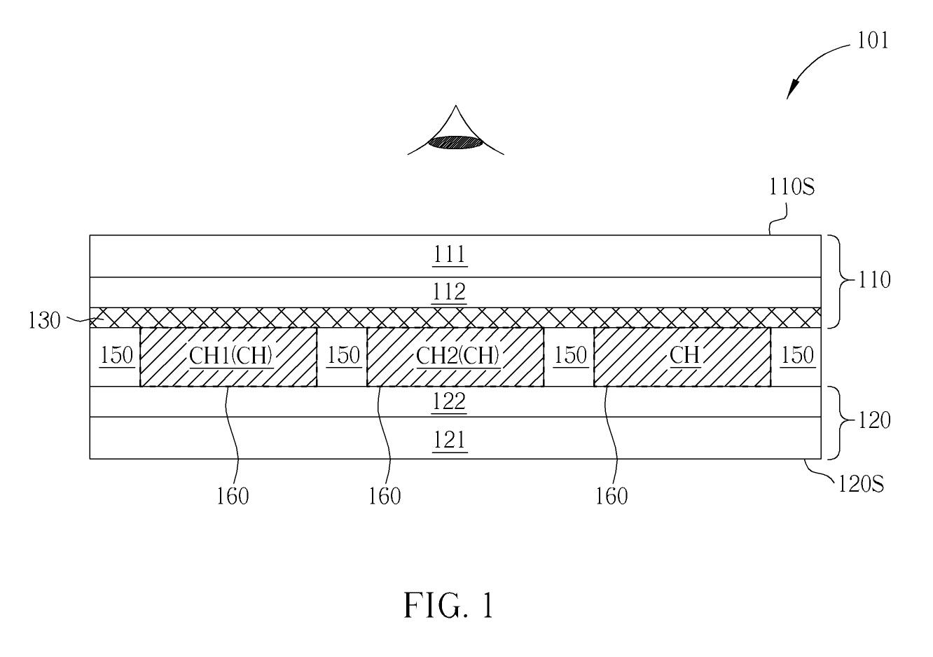

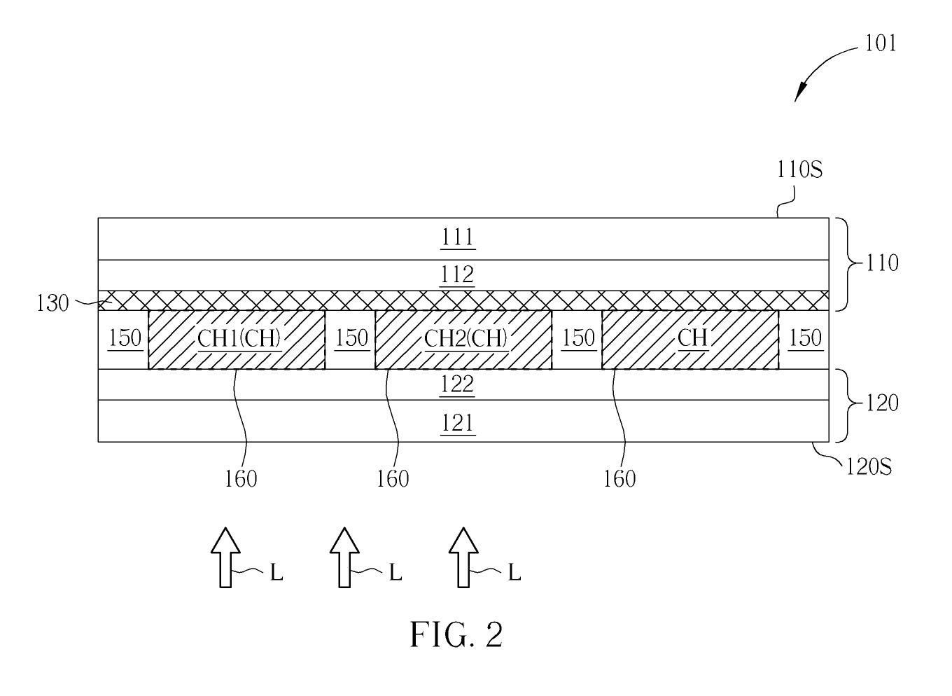

Please refer to FIG. 1 and FIG. 2. FIG. 1 and FIG. 2 are schematic diagrams illustrating a reflective liquid crystal display device according to a first preferred embodiment of the present invention. FIG. 2 is a schematic diagram illustrating an exposure process executed to the reflective liquid crystal display device. As shown in FIG. 1, a reflective liquid crystal display device 101 of this embodiment includes an upper substrate 110, a lower substrate 120, a plurality of isolation structures 150, and a plurality of photoreactive liquid crystals CH. The lower substrate 120 is disposed opposite to the upper substrate 110. The isolation structures 150 are disposed between the upper substrate 110 and the lower substrate 120 to form a plurality of channels 160 between the upper substrate 110 and the lower substrate 120. Each of the photoreactive liquid crystals CH is respectively disposed in each of the channels 160. The photoreactive liquid crystals CH are reactive to light. In other words, after being irradiated by light with proper energy, such as ultraviolet, the photoreactive liquid crystals CH may be converted to liquid crystals capable of reflecting light within different wavelength ranges, but not limited thereto. For example, a first photoreactive liquid crystal CH1 and a second photoreactive liquid crystal CH2 may be formed in different channels 160 after irradiating at least some of the photoreactive liquid crystals CH in different channels 160 with ultraviolet during an exposure process. The first photoreactive liquid crystal CH1 and the second photoreactive liquid crystal CH2 may be capable of reflecting light within different wavelength ranges, such as red light and green light, by modifying exposure energy of the exposure process and material content of the photoreactive liquid crystal CH, but not limited thereto. Additionally, the photoreactive liquid crystals CH may be originally capable of reflecting light within a specific wavelength range, such as blue light, but not limited thereto. Different reflected colors may be respectively generated by the photoreactive liquid crystal CH, the first photoreactive liquid crystal CH1, and the second photoreactive liquid crystal CH2. A full-color display effect may be accordingly obtained by mixing the reflected colors. However, the photoreactive liquid crystal CH, the first photoreactive liquid crystal CH1, and the second photoreactive liquid crystal CH2 may still be deteriorated by the ambient light after the exposure process, and the display effect may be affected accordingly. Therefore, the upper substrate 110 in this embodiment is capable of blocking ultraviolet, and the upper substrate 110 may be used to block the ultraviolet of the ambient light so as to keep the ultraviolet from irradiating the photoreactive liquid crystal CH, the first photoreactive liquid crystal CH1, and the second photoreactive liquid crystal CH2. The reliability of the reflective liquid crystal display device 101 may be accordingly enhanced.

As shown in FIG. 1, the upper substrate 110 in this embodiment includes an upper transparent substrate 111, an ultraviolet blocking layer 130, and an upper electrode 112. The lower substrate 120 includes a lower transparent substrate 121 and a lower electrode 122. The reflective display effects respectively generated by the photoreactive liquid crystal CH, the first photoreactive liquid crystal CH1, and the second photoreactive liquid crystal CH2 may be controlled by adjusting an electrical condition between the upper electrode 112 and the lower electrode 122. Additionally, in this embodiment, the upper electrode 112 is disposed between the upper transparent substrate 111 and the ultraviolet blocking layer 130, and the ultraviolet blocking layer 130 is disposed between the upper transparent substrate 111 and the lower substrate 120, but not limited thereto. It is worth noting that the ultraviolet blocking layer 130 may include a multi-layer structure, and materials with different refractive indexes may be employed in different layers of the multi-layer structure so as to generate an ultraviolet blocking effect. Additionally, the ultraviolet blocking layer 130 may also include an ultraviolet absorbing material, such as 2,4-Dihydroxybenzophenone, 2-Hydroxy-4-Methoxybenzophenone, or 2-(2′-Hydroxy-5′-methylphenyl) benzotriazole, but not limited thereto. The above-mentioned ultraviolet absorbing materials may also be employed in the ultraviolet blocking layer 130 to generate the ultraviolet blocking effect. In addition, the upper substrate 110 has an outer surface 110S, and the outer surface 110S in this embodiment may be a display surface of the reflective liquid crystal display device 101. Therefore, a light absorbing layer (not shown) may be selectively disposed on an outer surface 120S of the lower substrate 120 to keep light passing through the photoreactive liquid crystal CH, the first photoreactive liquid crystal CH1, and the second photoreactive liquid crystal CH2 from being reflected to influence the display effect.

As shown in FIG. 2, in a manufacturing method of the reflective liquid crystal display device 101 in this embodiment, the upper electrode 112 and the ultraviolet blocking layer 130 may be formed sequentially on the upper transparent substrate 111, and the upper substrate 110 and the lower substrate 120 may then be combined by the isolation structures 150, which may be adhesive, so as to form the channels 160 between the upper substrate 110 and the lower substrate 120. Subsequently, each of the channels 160 may be filled with the photoreactive liquid crystals CH. One or more exposure processes may be employed to provide a light beam L irradiating some of the photoreactive liquid crystals CH to form the first photoreactive liquid crystal CH1 and the second photoreactive liquid crystal CH2 in different channels 160. The light beam L in this embodiment is preferably an ultraviolet light beam, but not limited thereto. It is worth noting that the light beam L of the exposure process may preferably irradiate the photoreactive liquid crystals CH from the outer surface 120S of the lower substrate 120 because the upper substrate 110 is capable of blocking ultraviolet. Additionally, some of the photoreactive liquid crystals CH, which are not designed to be irradiated by the exposure process, may also be protected by the ultraviolet blocking layer 130 during the exposure process, and the display quality of the reflective liquid crystal display device 101 may be ensured accordingly.

In this embodiment, the upper transparent substrate 111 and the lower transparent substrate 121 may include glass substrates, polyethylene terephthalate (PET) substrates, polyethersulfone (PES) substrates, or polyimide (PI) substrates, but not limited thereto, other substrates made of other proper material can also be used in the present invention. The upper electrode 112 and the lower electrode 122 may include transparent conductive material such as indium tin oxide (ITO), indium zinc oxide (IZO), aluminum zinc oxide (AZO), zinc oxide, or tin oxide, but not limited thereto. The isolation structures 150 may preferably include materials such as epoxy, acrylic or other proper materials, and a manufacturing process of the isolation structures 150 may include a printing process, a photolithography process, or other proper processes. A thickness of the isolation structure 150 is preferably and substantially smaller than or equal to 30 micrometers so as to control the space of each channel 160, but not limited thereto. The photoreactive liquid crystals CH may include a liquid crystal monomer, a dye, a chiral reagent, an initiator, a cross-linking agent, or a photo-curable material, but not limited thereto. The liquid crystal monomer mentioned above may include a nematic liquid crystal monomer, a cholesteric liquid crystal monomer, or a mixture of different adequate liquid crystal monomers. The chiral reagent mentioned above may include a cyano chiral reagent, a cholesteryl nonanoate chiral reagent, a non-racemic chiral reagent, a macromolecular helicity chiral reagent, an azobenzenes chiral reagent, a ZLI chiral reagent, a binaphthalene chiral, a dipolar chiral reagent, a SPE chiral reagent, or other appropriate chiral reagents. The photo-curable material mentioned above may include a photoreactive functional group, such as a mono-functional monomer, a multi-functional monomer, a mono-functional oligomer, a multi-functional oligomer, or a double-naphthol functional monomer. The initiator mentioned above may include a radical initiator or a cation initiator. Components of the initiator may include a mono-functional monomer, a multi-functional monomer, a mono-functional oligomer, a multi-functional oligomer, or a hardener. The cross-linking agent mentioned above may include a biphenyl cross-linking agent, but not limited thereto. Additionally, the reflective liquid crystal display device 101 in this embodiment may further include an adhesive layer (not shown) disposed between the upper substrate 110 and the lower substrate 120 so as to enhance the combination of the upper substrate 110 and the lower substrate 120. The adhesive layer mentioned above may include materials such as epoxy, acrylic or other proper transparent adhesives.

The following description will detail the different embodiments of the reflective liquid crystal display device in the present invention. To simplify the description, the identical components in each of the following embodiments are marked with identical symbols. For making it easier to understand the differences between the embodiments, the following description will detail the dissimilarities among different embodiments and the identical features will not be redundantly described.

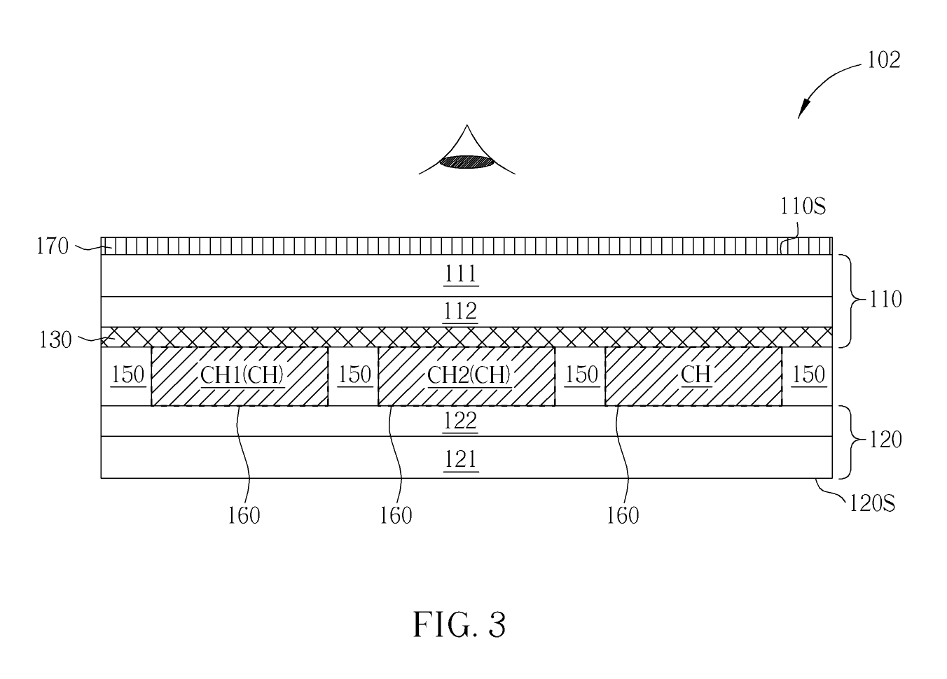

Please refer to FIG. 3. FIG. 3 is a schematic diagram illustrating a reflective liquid crystal display device according to a second preferred embodiment of the present invention. As shown in FIG. 3, the difference between a reflective liquid crystal display device 102 of this embodiment and the reflective liquid crystal display device 101 of the first preferred embodiment is that the liquid crystal display device 102 further includes an anti-reflection layer 170 disposed on the outer surface 110S of the upper substrate 110. The anti-reflection layer 170 may be used to increase an amount of light entering from the outer surface 110S and irradiating the photoreactive liquid crystal CH, the first photoreactive liquid crystal CH1, and the second photoreactive liquid crystal CH2. The reflected effects generated by the photoreactive liquid crystal CH, the first photoreactive liquid crystal CH1, and the second photoreactive liquid crystal CH2 may be accordingly enhanced. In other words, the anti-reflection layer 170 may be used to increase a display reflectivity of the reflective liquid crystal display device 102. In this embodiment, the anti-reflection layer 170 may include an anti-reflection layer formed by a dry manufacturing method or a wet manufacturing method. The dry manufacturing method mentioned above may include sputtering, vapor deposition, or other appropriate dry depositions. The wet manufacturing method mentioned above may include dipping, spin coating, or spray-on coating, but not limited thereto.

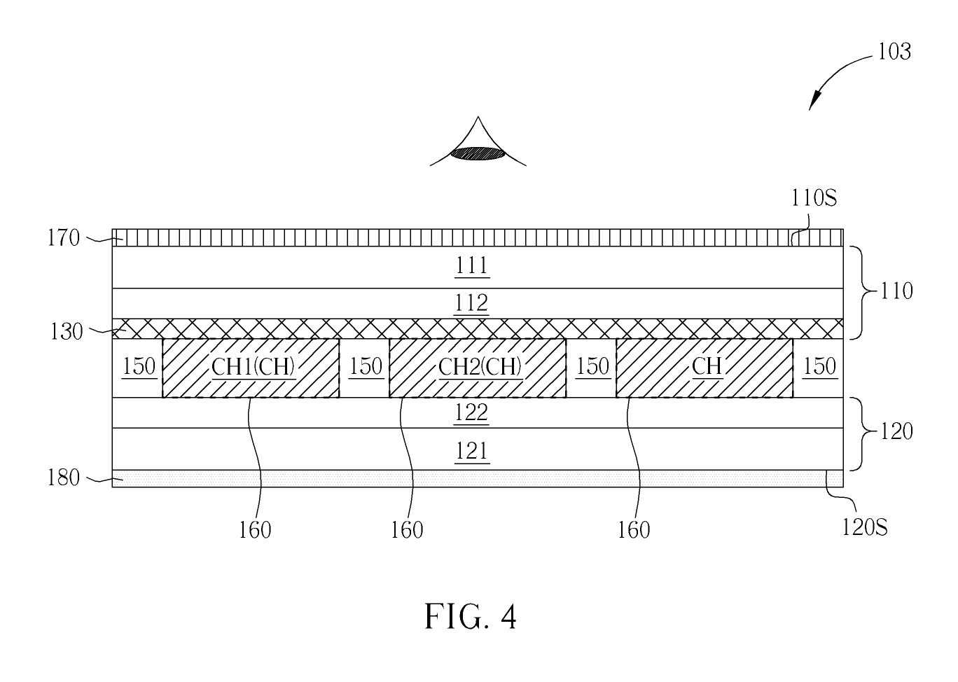

Please refer to FIG. 4. FIG. 4 is a schematic diagram illustrating a reflective liquid crystal display device according to a third preferred embodiment of the present invention. As shown in FIG. 4, the difference between a reflective liquid crystal display device 103 of this embodiment and the reflective liquid crystal display device 102 of the second preferred embodiment is that the reflective liquid crystal display device 103 further includes a light absorbing layer 180 disposed on the outer surface 120S of the lower substrate 120. The light absorbing layer 180 may be used to absorb light passing through the photoreactive liquid crystal CH, the first photoreactive liquid crystal CH1, and the second photoreactive liquid crystal CH2 so as to keep the light from being reflected toward the outer surface 110S of the upper substrate 110, which is the display surface of the reflective liquid crystal display device 103, and affecting the display effect.

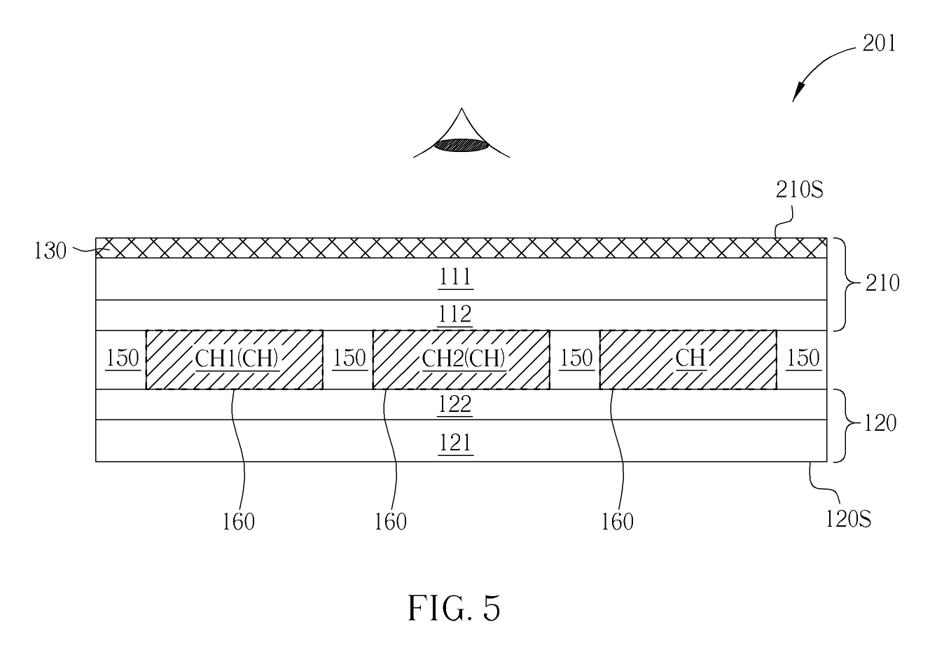

Please refer to FIG. 5. FIG. 5 is a schematic diagram illustrating a reflective liquid crystal display device according to a fourth preferred embodiment of the present invention. As shown in FIG. 5, the difference between a reflective liquid crystal display device 201 of this embodiment and the reflective liquid crystal display device 101 of the first preferred embodiment is that an upper substrate 210 of the reflective liquid crystal display device 201 includes an upper transparent substrate 111, an ultraviolet blocking layer 130, and an upper electrode 112. The upper transparent substrate 111 is disposed between the ultraviolet blocking layer 130 and the upper electrode 112, and the upper electrode 112 is disposed between the upper transparent substrate 111 and the lower substrate 120. In other words, an outer surface 210S of the upper substrate 210 is a surface of the ultraviolet blocking layer 130. It is worth noting that the exposure process, which is used to irradiate the reactive liquid crystal CH, may be executed before or after forming the ultraviolet blocking layer 130 because the ultraviolet blocking layer 130 is relatively disposed on an outer part of the reflective liquid crystal display device 201. The flexibility and the yield of the manufacturing process may be accordingly enhanced. Apart from the allocation approach of the upper transparent substrate 111, the ultraviolet blocking layer 130, and the upper electrode 112 in the upper substrate 210 of this embodiment, the other components and material properties of this embodiment are similar to those of the reflective liquid crystal display device 101 in the first preferred embodiment detailed above, and will not be redundantly described.

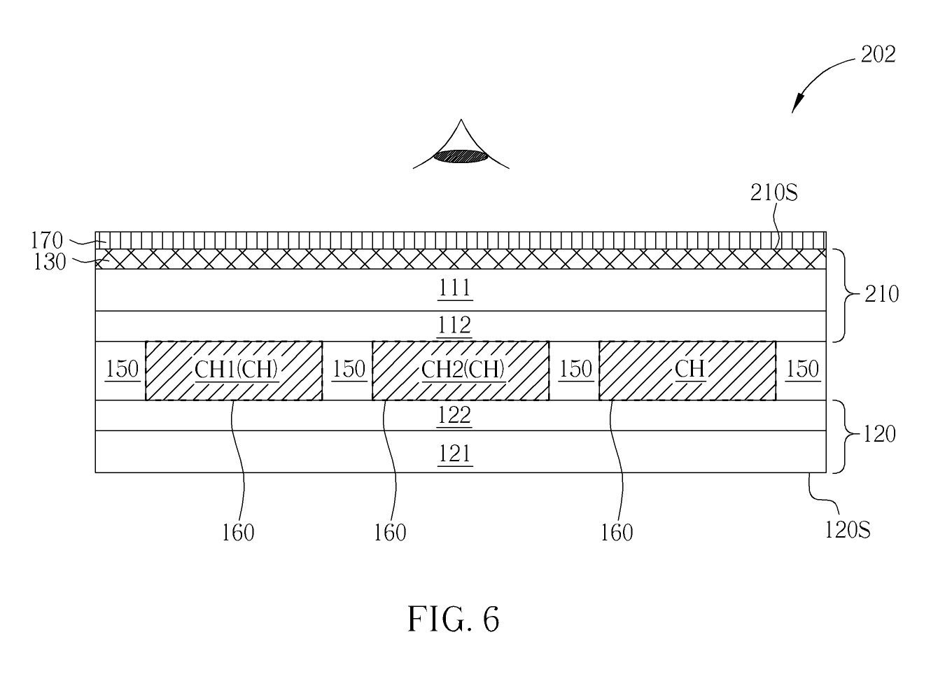

Please refer to FIG. 6. FIG. 6 is a schematic diagram illustrating a reflective liquid crystal display device according to a fifth preferred embodiment of the present invention. As shown in FIG. 6, the difference between a reflective liquid crystal display device 202 of this embodiment and the reflective liquid crystal display device 201 of the fourth preferred embodiment is that the reflective liquid crystal display device 202 further includes an anti-reflection layer 170 disposed on the ultraviolet blocking layer 130. Additionally, in this embodiment, a light absorbing layer (not shown) may be selectively disposed on the outer surface 120S of the lower substrate 120 so as to enhance the display effect.

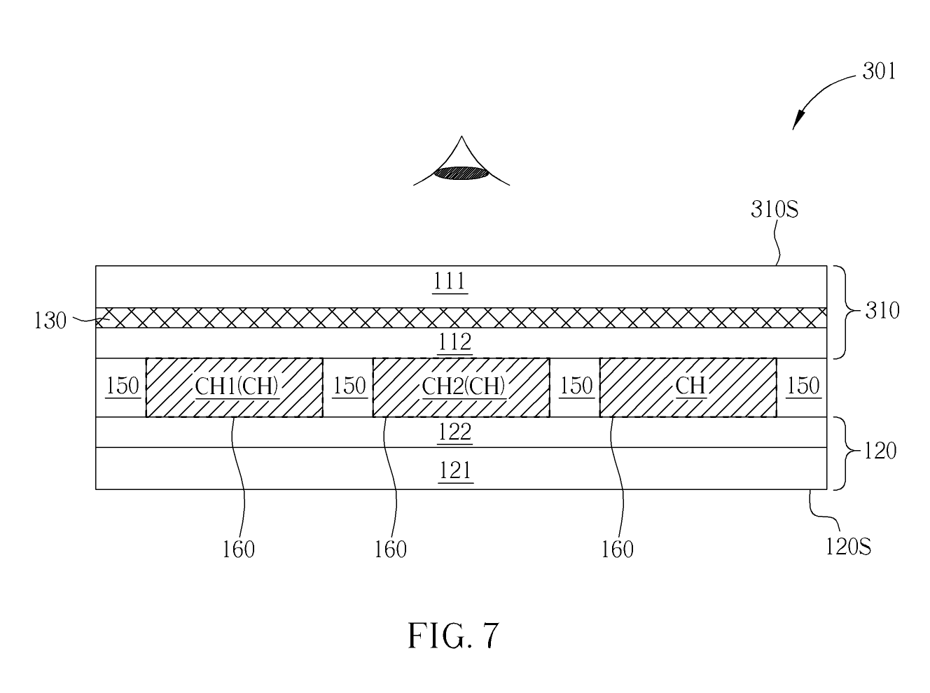

Please refer to FIG. 7. FIG. 7 is a schematic diagram illustrating a reflective liquid crystal display device according to a sixth preferred embodiment of the present invention. As shown in FIG. 7, the difference between a reflective liquid crystal display device 301 of this embodiment and the reflective liquid crystal display device 101 of the first preferred embodiment is that an upper substrate 310 of the reflective liquid crystal display device 301 includes an upper transparent substrate 111, an ultraviolet blocking layer 130, and an upper electrode 112. The ultraviolet blocking layer 130 is disposed between the upper transparent substrate 111 and the upper electrode 112, and the upper electrode 112 is disposed between the ultraviolet blocking layer 130 and the lower substrate 120. In other words, an outer surface 310S of the upper substrate 310 is a surface of the upper transparent substrate 111. Apart from the allocation approach of the upper transparent substrate 111, the ultraviolet blocking layer 130, and the upper electrode 112 in the upper substrate 310 of this embodiment, the other components and material properties of this embodiment are similar to those of the reflective liquid crystal display device 101 in the first preferred embodiment detailed above, and will not be redundantly described.

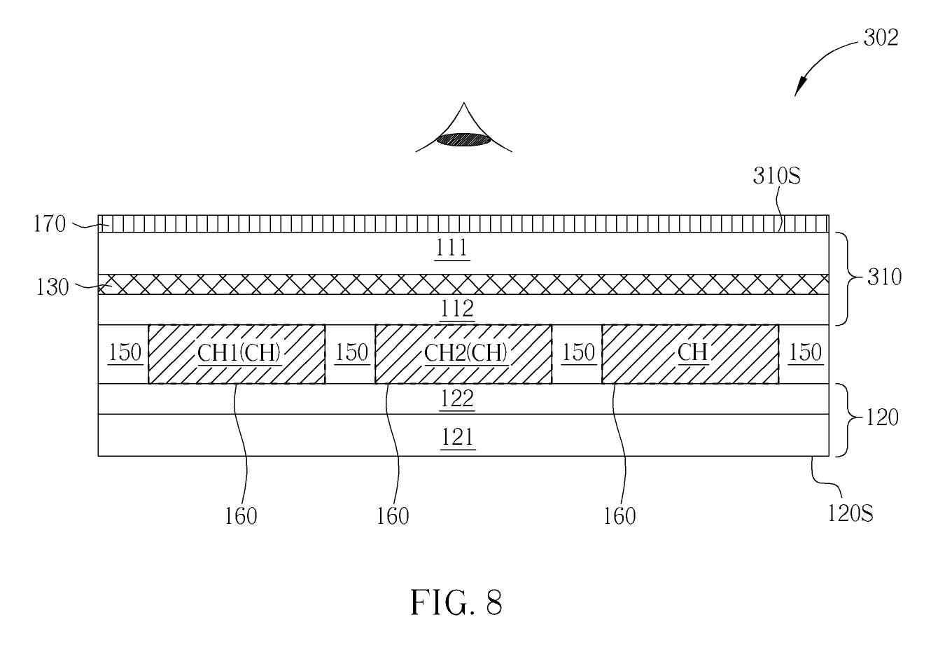

Please refer to FIG. 8. FIG. 8 is a schematic diagram illustrating a reflective liquid crystal display device according to a seventh preferred embodiment of the present invention. As shown in FIG. 8, the difference between a reflective liquid crystal display device 302 of this embodiment and the reflective liquid crystal display device 301 of the sixth preferred embodiment is that the reflective liquid crystal display device 302 further includes an anti-reflection layer 170 disposed on the outer surface 310S of the upper substrate 310. Additionally, in this embodiment, a light absorbing layer (not shown) may be selectively disposed on the outer surface 120S of the lower substrate 120 so as to enhance the display effect.

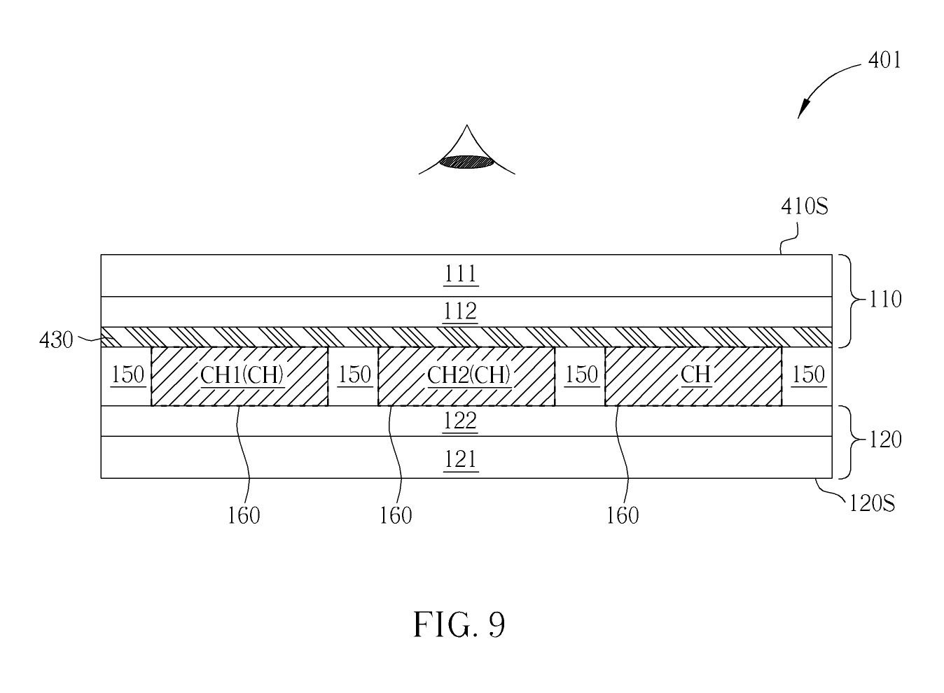

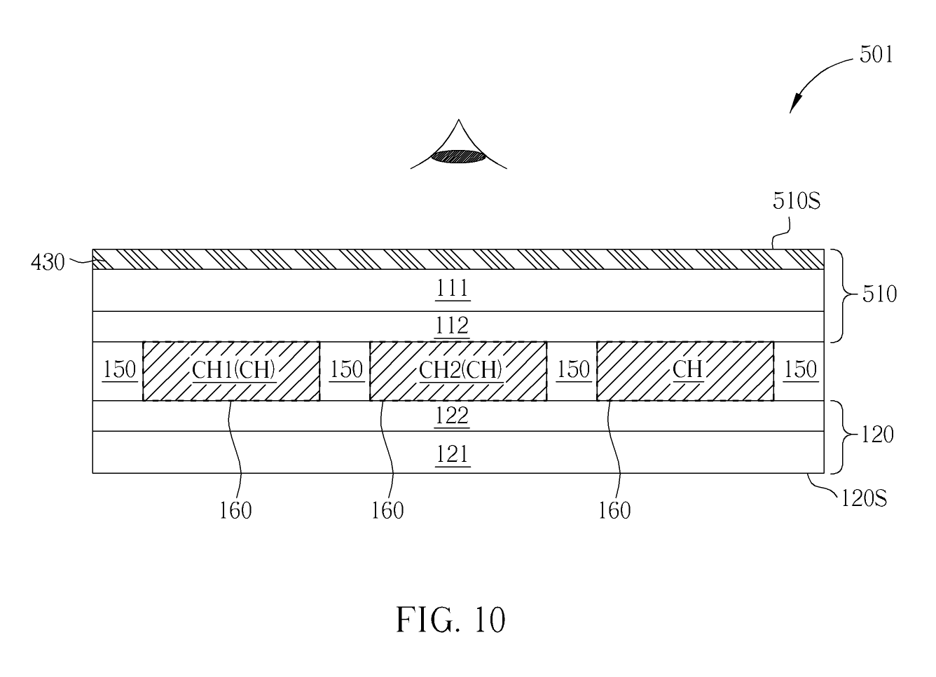

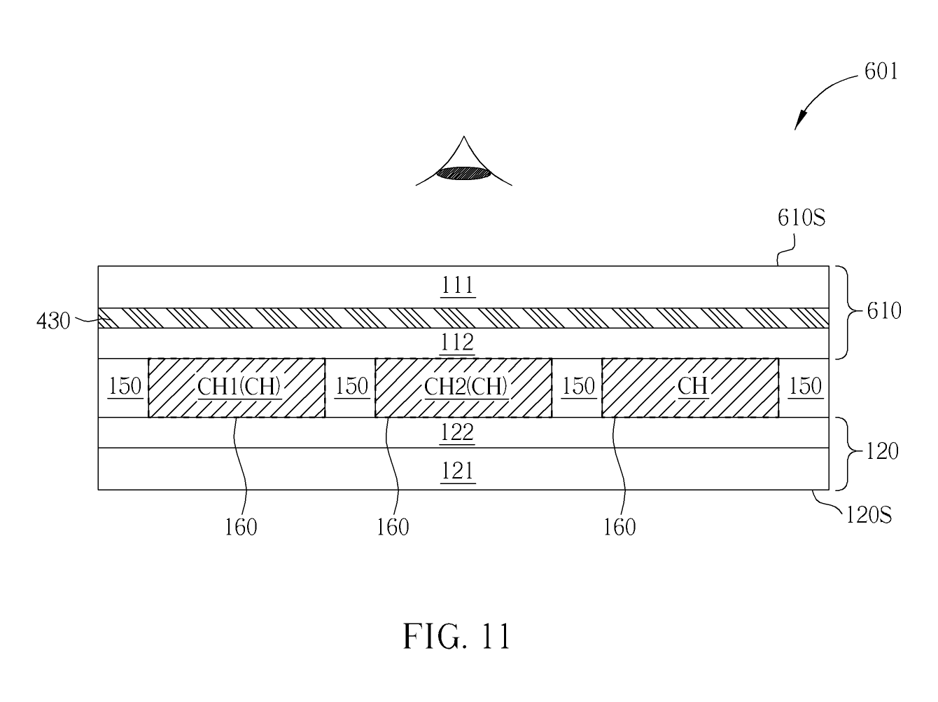

Please refer to FIGS. 9-11. FIG. 9 is a schematic diagram illustrating a reflective liquid crystal display device according to an eighth preferred embodiment of the present invention. FIG. 10 is a schematic diagram illustrating a reflective liquid crystal display device according to a ninth preferred embodiment of the present invention. FIG. 11 is a schematic diagram illustrating a reflective liquid crystal display device according to a tenth preferred embodiment of the present invention. As shown in FIGS. 9-11, in reflective liquid crystal display devices 401, 501, and 601, upper substrates 410, 510, 610 respectively includes an upper transparent substrate 111, an ultraviolet blocking layer 430, and an upper electrode 112. It is worth noting that the ultraviolet blocking layer 430 may include an anti-reflection layer doped with an ultraviolet absorbing material. In other words, the ultraviolet blocking layer 430 may be used for anti-reflection and blocking ultraviolet at the same time. The purpose of structure simplification may be accordingly achieved. The ultraviolet absorbing material doped in the ultraviolet blocking layer 430 may include 2,4-Dihydroxybenzophenone, 2-Hydroxy-4-Methoxybenzophenone, or 2-(2′-Hydroxy-5′-methylphenyl) benzotriazole, but not limited thereto. Additionally, in other embodiments of the present invention, the ultraviolet blocking layer 430 may include a multi-layer structure having both the ultraviolet blocking and anti-reflection properties. Additionally, in the reflective liquid crystal display devices 401, 501, and 601, outer surfaces 410S, 510S, and 610S are the display surfaces. A light absorbing layer (not shown) may be selectively disposed on the outer surface 120S of the lower substrate 120 so as to enhance the display effect. Apart from the ultraviolet blocking layer 430 in the eighth embodiment, the ninth embodiment, and the tenth embodiment, the other components and material properties of these embodiments are respectively similar to those of the reflective liquid crystal display devices 101, 201, and 301 in the preferred embodiments detailed above, and will not be redundantly described.

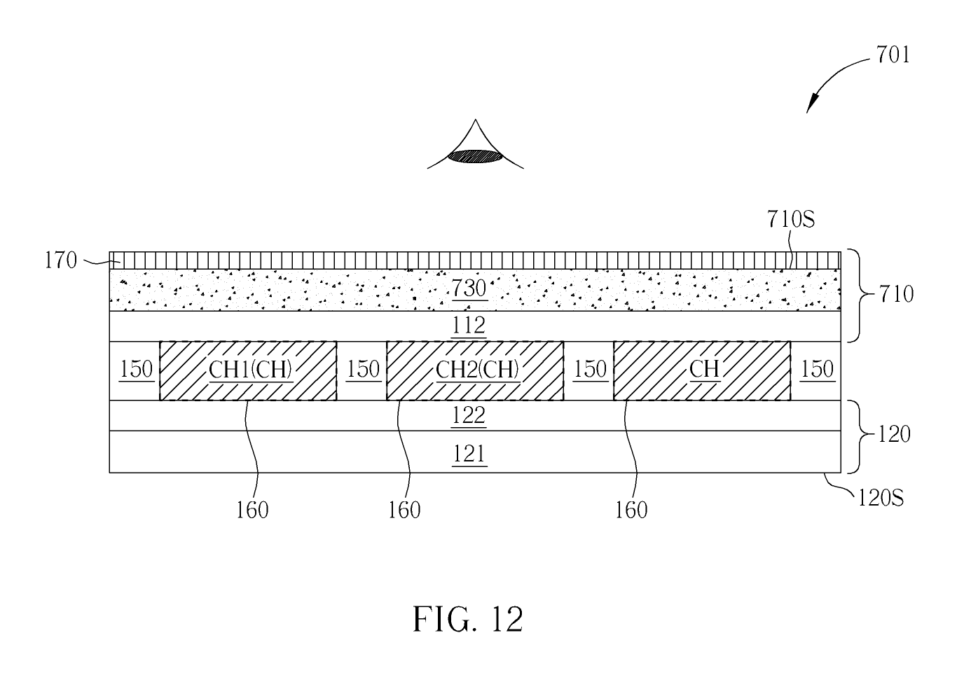

Please refer to FIG. 12. FIG. 12 is a schematic diagram illustrating a reflective liquid crystal display device according to an eleventh second preferred embodiment of the present invention. As shown in FIG. 12, the difference between a reflective liquid crystal display device 701 of this embodiment and the reflective liquid crystal display device 102 of the second preferred embodiment is that an upper substrate 710 of the reflective liquid crystal display device 701 includes an ultraviolet blocking substrate 730 and an upper electrode 112, and the upper electrode 112 is disposed between the ultraviolet blocking substrate 710 and the lower substrate 120. It is worth noting that the ultraviolet blocking substrate 730 may be a transparent substrate doped with an ultraviolet absorbing material or a multi-layer substrate including materials with different refractive indexes to generate the ultraviolet blocking effect. The ultraviolet absorbing material mentioned above may include materials such as 2,4-Dihydroxybenzophenone, 2-Hydroxy-4-Methoxybenzophenone, or 2-(2′-Hydroxy-5′-methylphenyl) benzotriazole, but not limited thereto. The purposes of structure simplification and thinner design of the reflective liquid crystal display device may be achieved by employed the ultraviolet blocking substrate 730 in this embodiment. The reflective liquid crystal display device 701 in this embodiment may further include an anti-reflection layer 170 disposed on an outer surface 710S of the upper substrate 710 so as to increase a display reflective ratio of the reflective liquid crystal display device 701. Additionally, a light absorbing layer (not shown) may be selectively disposed on the outer surface 120S of the lower substrate 120 so as to enhance the display effect. Apart from the ultraviolet blocking substrate 730 this embodiment, the other components and material properties of this embodiment are similar to those of the reflective liquid crystal display device 202 in the fifth preferred embodiment detailed above, and will not be redundantly described.

To summarize the above descriptions, in the present invention, the ultraviolet blocking layer or the ultraviolet blocking substrate is disposed in the reflective liquid crystal display device so as to keep ambient light from deteriorating the photoreactive liquid crystals and enhance the reliability of the reflective liquid crystal display device accordingly. In addition, the anti-reflection layer or the ultraviolet blocking layer integrate with the anti-reflection function is employed in the reflective liquid crystal display device so as to improve the display effects of the reflective liquid crystal display device employing the photoreactive liquid crystals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A reflective liquid crystal display device, comprising:
an upper substrate;
a lower substrate, disposed opposite to the upper substrate;
a plurality of isolation structures, disposed between the upper substrate and the lower substrate, wherein the isolation structures are used to form a plurality of channels between the upper substrate and the lower substrate; and
a plurality of photoreactive liquid crystals, respectively disposed in each of the channels, wherein the upper substrate is used to block ultraviolet.

2. The reflective liquid crystal display device of claim 1, wherein the upper substrate comprises an upper transparent substrate, an ultraviolet blocking layer, and an upper electrode.

3. The reflective liquid crystal display device of claim 2, wherein the upper electrode is disposed between the upper transparent substrate and the ultraviolet blocking layer, and the ultraviolet blocking layer is disposed between the upper transparent substrate and the lower substrate.

4. The reflective liquid crystal display device of claim 2, wherein the upper transparent substrate is disposed between the ultraviolet blocking layer and the upper electrode, and the upper electrode is disposed between the upper transparent substrate and the lower substrate.

5. The reflective liquid crystal display device of claim 2, wherein the ultraviolet blocking layer is disposed between the upper transparent substrate and the upper electrode, and the upper electrode is disposed between the ultraviolet blocking layer and the lower substrate.

6. The reflective liquid crystal display device of claim 2, wherein the ultraviolet blocking layer comprises a multi-layer structure.

7. The reflective liquid crystal display device of claim 2, wherein the ultraviolet blocking layer comprises an ultraviolet absorbing material.

8. The reflective liquid crystal display device of claim 2, wherein the ultraviolet blocking layer comprises an anti-reflection layer doped with an ultraviolet absorbing material.

9. The reflective liquid crystal display device of claim 1, further comprising an anti-reflection layer disposed on an outer surface of the upper substrate.

10. The reflective liquid crystal display device of claim 1, wherein the upper substrate comprises an ultraviolet blocking substrate and an upper electrode, and the upper electrode is disposed between the ultraviolet blocking substrate and the lower substrate.

11. The reflective liquid crystal display device of claim 1, further comprising a light absorbing layer disposed on an outer surface of the lower substrate.

12. The reflective liquid crystal display device of claim 7, wherein the ultraviolet absorbing material comprises 2,4-Dihydroxybenzophenone, 2-Hydroxy-4-Methoxybenzophenone, or 2-(2′-Hydroxy-5′-methylphenyl) benzotriazole.
